(19) United States
(12) Patent Application Publication
(10) Pub. No.: US 2015/0277484 A1
(43) Pub. Date: Oct. 1, 2015

(54) TOUCH MODULE

(71) Applicant: YOMORE TECHNOLOGY CO., LTD., KAOHSIUNG CITY (TW)

(72) Inventors: Jao-Ching Lin, KAOHSIUNG CITY (TW); Wen-Ting Lee, KAOHSIUNG CITY (TW); Chung-Yi Shen, KAOHSIUNG CITY (TW)

(21) Appl. No.: 14/533,066

(22) Filed: Nov. 4, 2014

(30) Foreign Application Priority Data
Mar. 31, 2014 (TW) 103111988

(51) Int. Cl. G06F 1/16; G06F 3/044

(52) U.S. Cl. CPC G06F 1/16; G06F 3/044

(57) ABSTRACT

A touch module includes a substrate and an electrode layer. The electrode layer is formed on the substrate. The electrode layer includes at least one first electrode row arranged along a first direction. The first electrode row includes a plurality of first electrode units arranged along a second direction. The densities of the first electrode units change according to a first predetermined ratio.

### BACKGROUND OF THE INVENTION

1. Field of the Invention

The invention relates to a touch module and, more particularly, to a touch module capable of improving yield rate and touch precision effectively.

2. Description of the Prior Art

Touch panels nowadays are gaining popularity for numerous applications including point-of-information kiosks, vending, electronic catalogs, in-store locators, corporate training, gaming, banking/financial transactions, ticket sales, and the like. A touch panel generally employs one of four types of touch technologies: capacitive, resistive, optics, and surface acoustic wave (SAW), wherein the capacitive touch panel is more popular than others.

In a capacitive touch panel, both sides of a substrate are coated with a conductive material and a scratch-proof film is covered on the outside. The electrodes on the substrate generate an electric field at low voltage. When a user touches the touch panel, the body of the user causes capacitance change in the touch panel. The capacitance change causes the controller to have differentials, and the differentials are converted into a corresponding X-Y coordinate.

In the prior art, a capacitive touch module comprises a substrate and a plurality of triangular electrodes. The triangular electrodes are formed on the substrate by a printing, etching or sputtering process. It is well known by one skilled in the art that it is difficult to form a sharp end of the triangular electrode by the aforesaid process, such that the yield rate is reduced and the touch precision at both edges of the touch module is affected accordingly. Furthermore, the capacitive touch module calculates a touch position according to a contact area ratio between the user's finger and two adjacent triangular electrodes. If the finger only contacts one triangular electrode, the capacitive touch module cannot calculate the touch position precisely.

### SUMMARY OF THE INVENTION

The invention provides a touch module capable of improving yield rate and touch precision effectively, so as to solve the aforesaid problems.

According to an embodiment of the invention, a touch module comprises a substrate and an electrode layer. The electrode layer is formed on the substrate. The electrode layer comprises at least one first electrode row arranged along a first direction. The first electrode row comprises a plurality of first electrode units arranged along a second direction. The densities of the first electrode units change according to a first predetermined ratio.

In this embodiment, the electrode layer further comprises at least one second electrode row arranged along the first direction, the second electrode row comprises a plurality of second electrode units arranged along the second direction, and the densities of the second electrode units change according to a second predetermined ratio.

In this embodiment, each of the first electrode units and each of the second electrode units are formed as a non-triangular polygon.

As mentioned in the above, since each of the first electrode units and each of the second electrode units are formed as a non-triangular polygon (e.g. rectangular), the first electrode units and the second electrode units of the invention do not have a sharp end of the triangular electrode of the prior art. Accordingly, the touch module of the invention can improve yield rate and touch precision at the edge portion effectively.

Furthermore, the touch module of the invention determines a touch position by the change of the densities of the electrode units and the sensing patterns (e.g. rectangular or polygonal) of the electrode units vary linearly. Accordingly, the determination of the touch position performed by the touch module of the invention is absolutely different from that of the prior art, which determines the touch position by limited area of the triangular electrode including the sharp end. Therefore, the invention can ensure that there is a largest contact area between each of the electrode units and the finger (e.g. the contact point of the finger is wholly located within the sensing region), so as to obtain the most sufficient sensing data and then improve the touch precision.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a touch module according to an embodiment of the invention.

FIG. 2 is a schematic diagram illustrating a touch module according to another embodiment of the invention.

FIG. 3 is a schematic diagram illustrating a touch module according to another embodiment of the invention.

FIG. 4 is a schematic diagram illustrating a touch module according to another embodiment of the invention.

FIG. 5 is a schematic diagram illustrating a touch module according to another embodiment of the invention.

FIG. 6 is a schematic diagram illustrating a touch module according to another embodiment of the invention.

### DETAILED DESCRIPTION

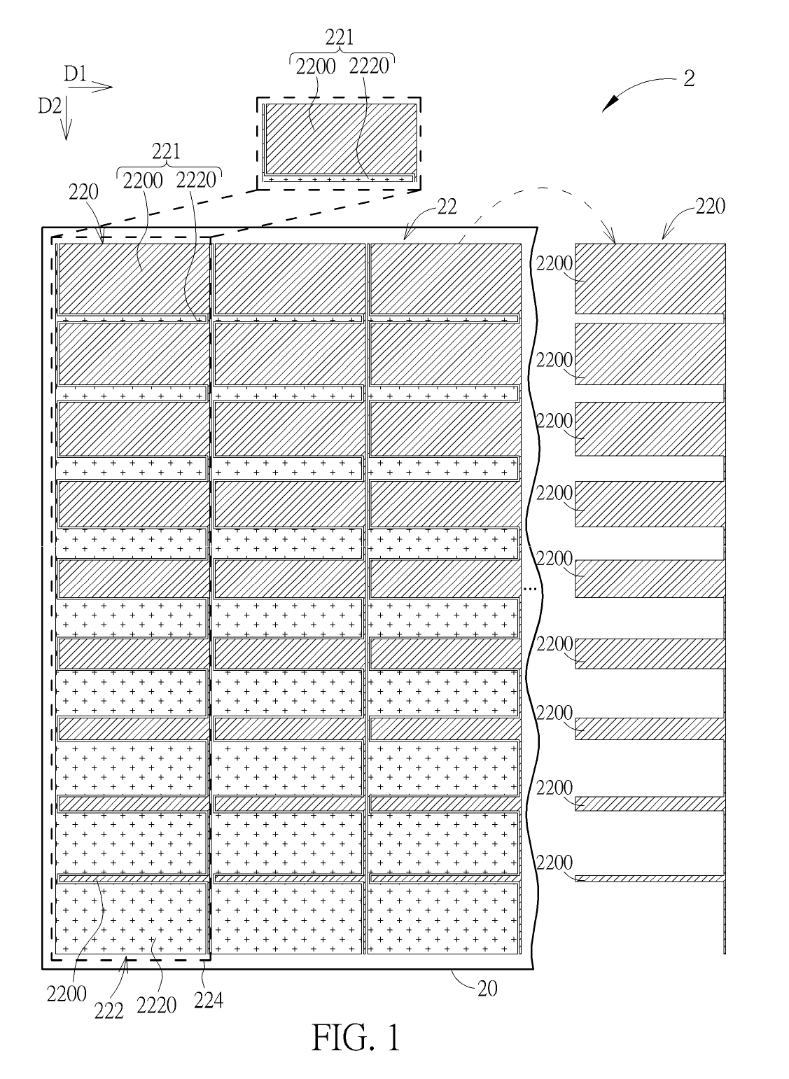

Referring to FIG. 1, FIG. 1 is a schematic diagram illustrating a touch module 2 according to an embodiment of the invention. As shown in FIG. 1, an electrode layer 22 comprises at least one first electrode row 220 arranged along a first direction D1, wherein the first electrode row 220 comprises a plurality of first electrode units 2200 arranged along a second direction D2 and the densities of the first electrode units 2200 change according to a first predetermined ratio.

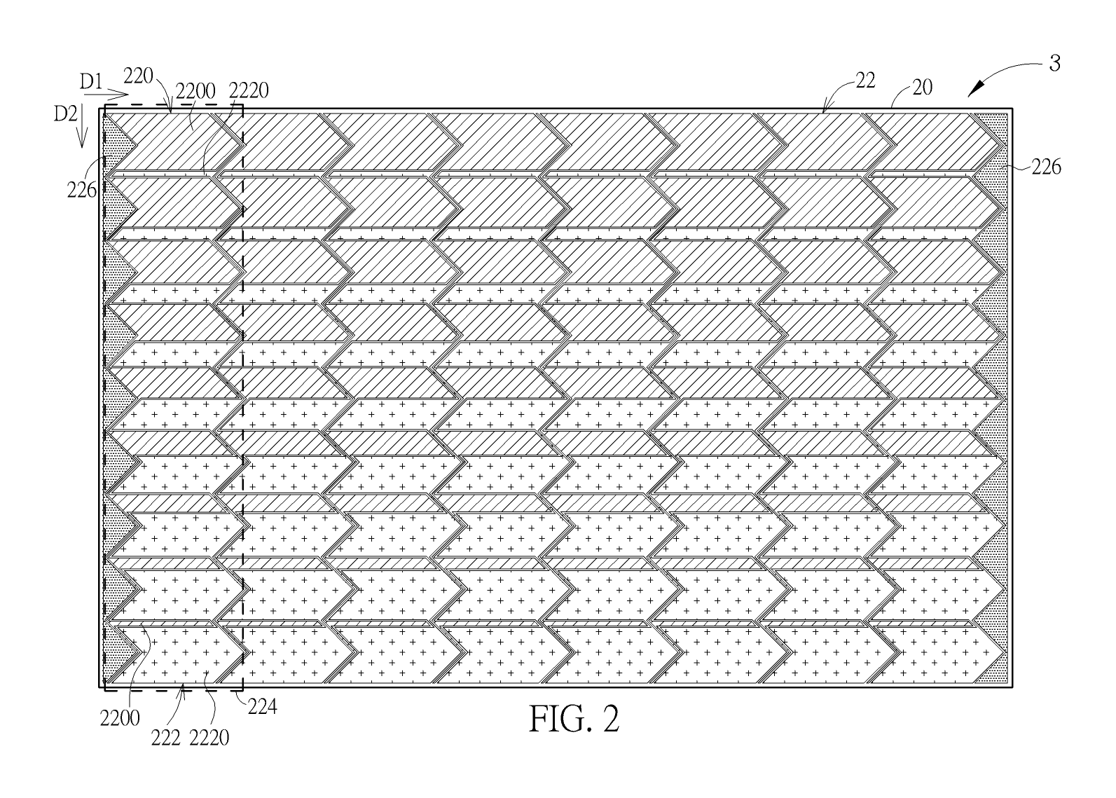

As shown in FIG. 2, the touch module 2 comprises a substrate 20 and an electrode layer 22. The electrode layer 22 is formed on the substrate 20. The electrode layer 22 may be formed on the substrate 20 by a printing process or other processes with transparent Indium Tin Oxide (ITO), Antimony Tin Oxide (ATO) or other electrode materials.

The electrode layer 22 comprises at least one first electrode row 220 arranged along the first direction D1 and at least one second electrode row 222 arranged along the first direction D1. In this embodiment, the electrode layer 22 comprises a plurality of first electrode rows 220 arranged along the first direction D1 and a plurality of second electrode rows 222 arranged along the first direction D1. Each of the first electrode rows 220 comprises a plurality of first electrode units 2200 arranged along the second direction D2, wherein the densities of the first electrode units 2200 change according to a first predetermined ratio. In this embodiment, the first predetermined ratio may be a gradually decreasing ratio along the second direction D2. Each of the second electrode rows 222 comprises a plurality of second electrode units 2220 arranged along the second direction D2, wherein the densities of the second electrode units 2220 change according to a second predetermined ratio. In this embodiment, the second predetermined ratio may be a gradually increasing ratio along the second direction D2. In other words, the densities of the first electrode units 2200 may decrease gradually in an equal ratio along the second direction D2 and the densities of the second electrode units 2220 may increase gradually in an equal ratio along the second direction D2. However, the invention is not limited to the aforesaid embodiment. The aforesaid density may be explained as follows. One first electrode unit 2200 and one second electrode unit 2220 may form one sensing unit 221. If an area of the first electrode unit 2200 is represented by A and an area of the second electrode unit 2220 is represented by B, the sum of A and B is constant. Accordingly, the density of the first electrode unit 2200 can be represented by A/(A+B) and the density of the second electrode unit 2220 can be represented by B/(A+B). For example, in a sensing unit 221, the density of the first electrode unit 2200 may be 90% and the density of the second electrode unit 2220 maybe 10% correspondingly; in another sensing unit 221, the density of the first electrode unit 2200 may be 80% and the density of the second electrode unit 2220 may be 20% correspondingly; and so on. Furthermore, as shown in the right of FIG. 1, the area ratio of each of the first electrode units 2200 in the same first electrode row 220 may be defined as follows. If an area is represented by N and the density thereof is 100%, the area (represented by A) of the first electrode unit 2200 is equal to 0.8 N and the area (represented by B) of another neighboring first electrode unit 2200 is equal to 0.8 N. Accordingly, the density of A is equal to 80% (i.e. A/N), the density of B is equal to 60% (i.e. B/N), and so on.

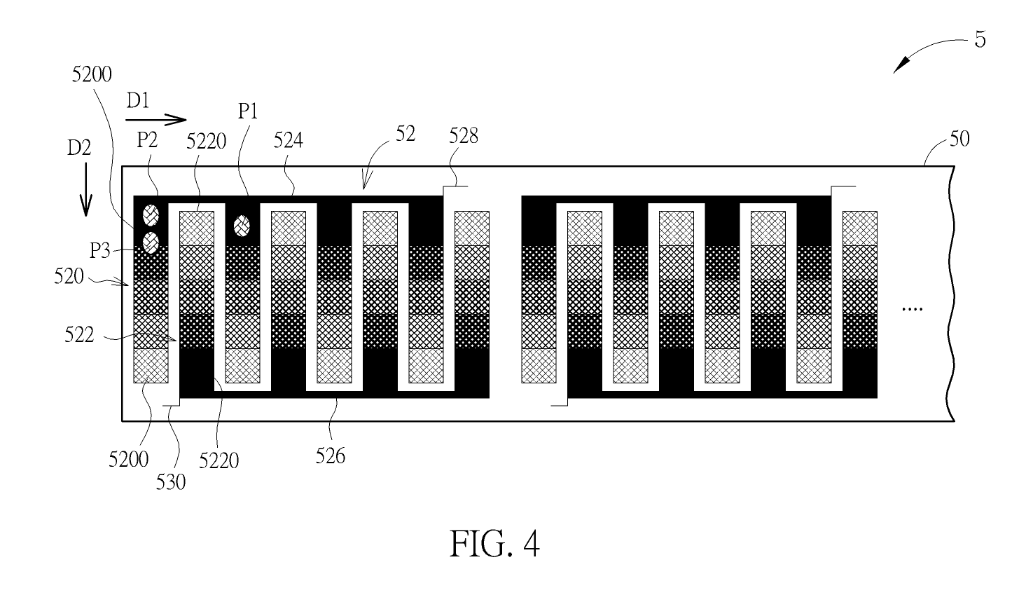

It should be noted that the concept of the density is not limited to the aforesaid embodiment. For example, when each of the electrode units is formed as a meshed structure (as shown in FIG. 4), a single electrode unit may be taken to be a sensing unit and the density of each single electrode unit maybe determined according to the meshed structure. For example, the sparser the meshed structure is, the lower the density is; and the denser the meshed structure is, the higher the density is.

In this embodiment, the first electrode units 2200 of each first electrode row 220 and the second electrode units 2220 of each second electrode row 222 are arranged interlacedly along the second direction D2, so as to form a plurality of main electrode rows 224. In other words, each of the main electrode rows 224 essentially consists of one first electrode row 220 and one second electrode row 222. The invention can calculate a touch position precisely by sensing capacitance variation of the first electrode row 220 and the second electrode row 222 touched by a finger.

In this embodiment, each of the first electrode units 2200 and each of the second electrode units 2220 are formed as rectangular. Since the first electrode units 2200 and the second electrode units 2220 of the invention do not have a sharp end of the triangular electrode of the prior art, the touch module 2 of the invention can improve yield rate and touch precision effectively. It should be noted that the first electrode units 2200 and the second electrode units 2220 are not limited to rectangular and may be formed as a non-triangular polygon (e.g. quadrangle, hexagon, octagon, etc.) according to practical applications.

Referring to FIG. 2, FIG. 2 is a schematic diagram illustrating a touch module 3 according to another embodiment of the invention. The main difference between the touch module 3 and the aforesaid touch module 2 is that a side of each of the main electrode rows 224 of the touch module 3 has a protruding portion and another side thereof has a recess portion, as shown in FIG. 2. When a touch point is located between two adjacent main electrode rows 224 (i.e. the touch point contacts the protruding portion and the recess portion of two adjacent main electrode rows 224 simultaneously), the capacitances of the two adjacent main electrode rows 224 will vary accordingly. Therefore, the invention can improve the touch precision along the first direction D1 effectively. Furthermore, the electrode layer 22 may further comprise two third electrode rows 226 located at opposite sides of all of the main electrode rows 224. Accordingly, the invention can improve the touch precision at opposite sides of the touch module 3 effectively. It should be noted that the same elements in FIG. 2 and FIG. 1 are represented by the same numerals, so the repeated explanation will not be depicted herein again.

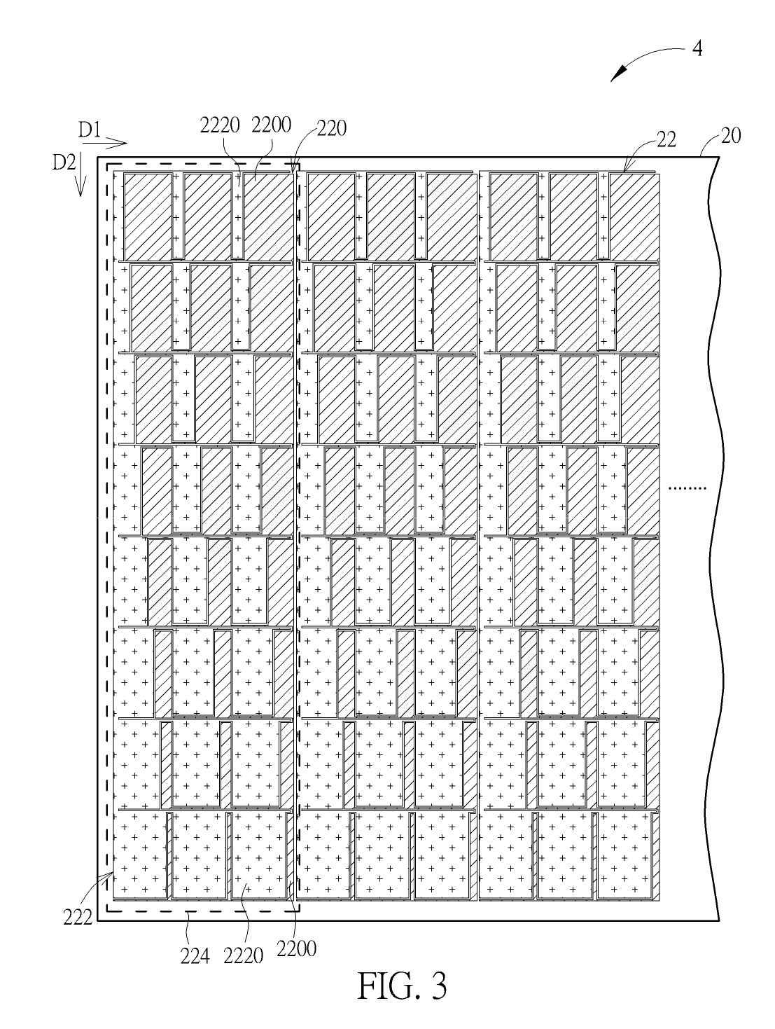

Referring to FIG. 3, FIG. 3 is a schematic diagram illustrating a touch module 4 according to another embodiment of the invention. The main difference between the touch module 4 and the aforesaid touch module 2 is that the first electrode units 2200 and the second electrode units 2220 of the touch module 4 may be divided into a plurality of sub-areas along the first direction D1, as shown in FIG. 3. Accordingly, the invention can further improve the touch precision along the first direction D1 and the second direction D2. It should be noted that the same elements in FIG. 3 and FIG. 1 are represented by the same numerals, so the repeated explanation will not be depicted herein again.

Referring to FIG. 4, FIG. 4 is a schematic diagram illustrating a touch module 5 according to another embodiment of the invention. As shown in FIG. 4, the touch module 5 comprises a substrate 50 and an electrode layer 52. The electrode layer 52 is formed on the substrate 50. The electrode layer 52 may be formed on the substrate 50 by a printing process or other processes with transparent Indium Tin Oxide (ITO), Antimony Tin Oxide (ATO) or other electrode materials.

In this embodiment, the electrode layer 52 comprises a plurality of first electrode rows 520 arranged along the first direction D1 and a plurality of second electrode rows 522 arranged along the first direction D1. Each of the first electrode rows 520 comprises a plurality of first electrode units 5200 arranged along the second direction D2, wherein each of the first electrode units 5200 is formed as a meshed structure and has a corresponding density, and the densities of the first electrode units 5200 change according to a first predetermined ratio. In this embodiment, the first predetermined ratio may be a gradually decreasing ratio along the second direction D2. Each of the second electrode rows 522 comprises a plurality of second electrode units 5220 arranged along the second direction D2, wherein each of the second electrode units 5220 is formed as a meshed structure and has a corresponding density, and the densities of the second electrode units 5220 change according to a second predetermined ratio. In this embodiment, the second predetermined ratio may be a gradually increasing ratio along the second direction D2. In other words, the densities of the first electrode units 5200 may decrease gradually in an equal ratio along the second direction D2 and the densities of the second electrode units 5220 may increase gradually in an equal ratio along the second direction D2. However, the invention is not limited to the aforesaid embodiment. The aforesaid density has been explained in the above, so the repeated explanation will not be depicted herein again.

In this embodiment, the first electrode rows 520 and the second electrode rows 522 are arranged interlacedly along the first direction D1, such that the first electrode rows 520 and the second electrode rows 522 are parallel to each other substantially. Furthermore, at least two first electrode rows 520 are connected to a first connecting portion 524 and at least two second electrode rows 522 are connected to a second connecting portion 526, wherein the first connecting portion 524 is connected to a first conducting wire 528 and the second connecting portion 526 is connected to a second conducting wire 530. The invention can calculate a touch position precisely by sensing capacitance variation of the first electrode row 520 and the second electrode row 522 touched by a finger.

In this embodiment, each of the first electrode units 5200 and each of the second electrode units 5220 are formed as rectangular. Since the first electrode units 5200 and the second electrode units 5220 of the invention do not have a sharp end of the triangular electrode of the prior art, the touch module 5 of the invention can improve yield rate and touch precision effectively. Moreover, since at least two first electrode rows 520 are connected to the first connecting portion 524 and at least two second electrode rows 522 are connected to the second connecting portion 526, the invention can reduce the number of the first conducting wires 528 and the second conducting wires 530 effectively, i.e. the invention can reduce the number of scanning lines effectively. It should be noted that the first electrode units 5200 and the second electrode units 5220 are not limited to rectangular and may be formed as a non-triangular polygon (e.g. quadrangle, hexagon, octagon, etc.) according to practical applications.

It should be noted that the first connecting portion 524 and the at least two first electrode rows 520 may be formed on the substrate 50 integrally by transparent Indium Tin Oxide (ITO), Antimony Tin Oxide (ATO) or other electrode materials, and the second connecting portion 526 and the at least two second electrode rows 522 may be formed on the substrate 50 integrally by transparent Indium Tin Oxide (ITO), Antimony Tin Oxide (ATO) or other electrode materials. Accordingly, the first connecting portion 524 and the second connecting portion 526 both have impedance characteristic. When there are two touch points P1, P2 located at the positions shown in FIG. 4, the capacitance variation sensed from the touch point P1 is larger than the capacitance variation sensed from the touch point P2 since the touch point P1 is closer to the first conducting wire 528 than the touch point P2. Therefore, even if the finger only touches one single electrode row, the invention still can calculate the touch position precisely according to the impedance characteristic of the first connecting portion 524 and the second connecting portion 526. Still further, as shown in FIG. 4, each of the first electrode units 5200 and the second electrode units 5220 is formed as a meshed structure and has a corresponding density, the densities of the first electrode units 5200 decrease gradually along the second direction D2, and the densities of the second electrode units 5220 increase gradually along the second direction D2. When there are two touch points P2, P3 located at the positions shown in FIG. 4, the invention still can calculate the touch positions precisely according to different area densities and area ratios. For example, since the density of the first electrode unit 5200 touched by the touch point P2 is larger than the density of another first electrode unit 5200 touched by the touch point P3, the invention can calculate the positions of the touch points P2, P3 precisely according to different area densities and area ratios.

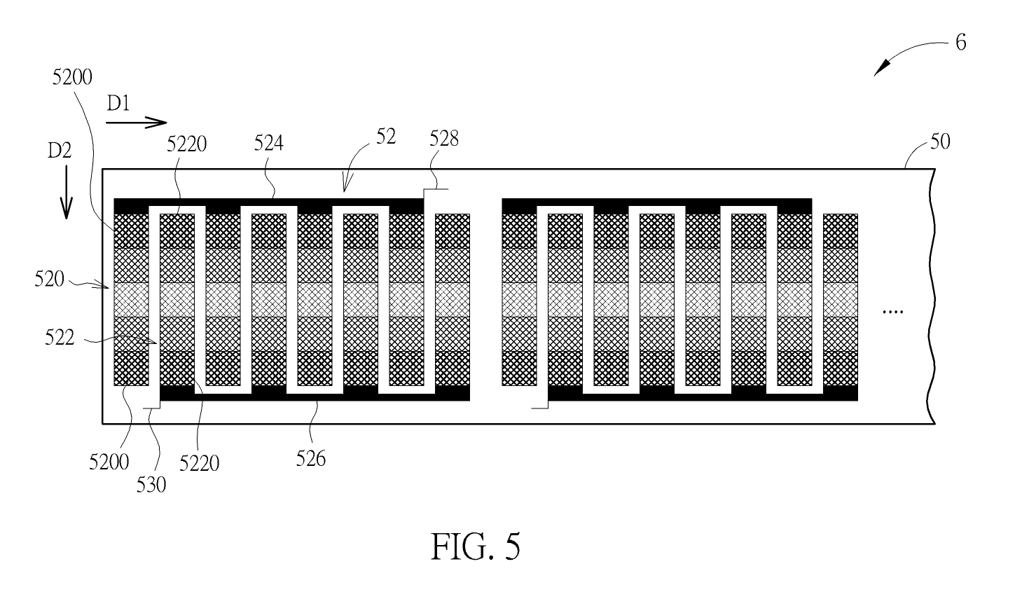

Referring to FIG. 5, FIG. 5 is a schematic diagram illustrating a touch module 6 according to another embodiment of the invention. The main difference between the touch module 6 and the aforesaid touch module 5 is that the densities of the first electrode units 5200 increase gradually in upward and downward directions and the densities of the second electrode units 5220 also increase gradually in upward and downward directions. In other words, the aforesaid first predetermined ratio and second predetermined ratio both are defined as to increase gradually in upward and downward directions. It should be noted that the same elements in FIG. 5 and FIG. 4 are represented by the same numerals, so the repeated explanation will not be depicted herein again.

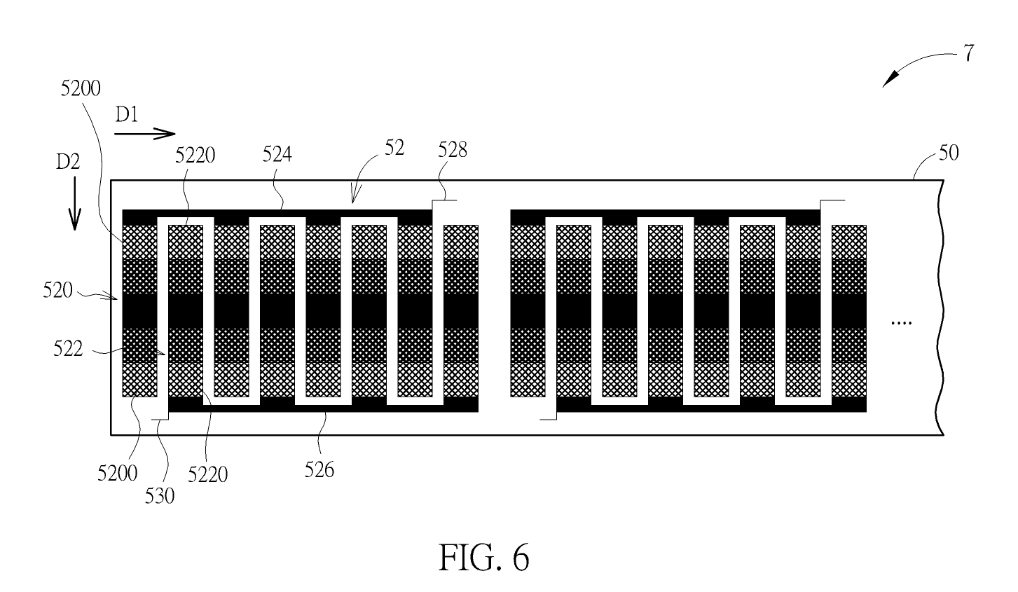

Referring to FIG. 6, FIG. 6 is a schematic diagram illustrating a touch module 7 according to another embodiment of the invention. The main difference between the touch module 7 and the aforesaid touch module 6 is that the densities of the first electrode units 5200 decrease gradually in upward and downward directions and the densities of the second electrode units 5220 also decrease gradually in upward and downward directions. In other words, the aforesaid first predetermined ratio and second predetermined ratio both are defined as to decrease gradually in upward and downward directions. It should be noted that the same elements in FIG. 6 and FIG. 5 are represented by the same numerals, so the repeated explanation will not be depicted herein again.

As mentioned in the above, since each of the first electrode units and each of the second electrode units are formed as a non-triangular polygon (e.g. rectangular), the first electrode units and the second electrode units of the invention do not have a sharp end of the triangular electrode of the prior art. Accordingly, the touch module of the invention can improve yield rate and touch precision at the edge portion effectively. Furthermore, a side of the main electrode row may have a protruding portion and another side of the main electrode row may have a recess portion, so as to improve the touch precision. Still further, the invention may dispose two third electrode rows at opposite sides of all of the main electrode rows, so as to improve the touch precision at opposite sides of the touch module.

Moreover, the touch module of the invention determines a touch position by the change of the densities of the electrode units and the sensing patterns (e.g. rectangular or polygonal) of the electrode units vary linearly. Accordingly, the determination of the touch position performed by the touch module of the invention is absolutely different from that of the prior art, which determines the touch position by limited area of the triangular electrode including the sharp end. Therefore, the invention can ensure that there is a largest contact area between each of the electrode units and the finger (e.g. the contact point of the finger is wholly located within the sensing region), so as to obtain the most sufficient sensing data and then improve the touch precision.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch module comprising:
a substrate;
an electrode layer, wherein the electrode layer comprises at least one first electrode row arranged along a first direction and the electrode layer is formed on the substrate;
the first electrode row, wherein the first electrode row comprises a plurality of first electrode units arranged along a second direction; and
the first electrode units, wherein densities of the first electrode units change according to a first predetermined ratio.

2. The touch module of claim 1, wherein the electrode layer further comprises at least one second electrode row arranged along the first direction, the second electrode row comprises a plurality of second electrode units arranged along the second direction, and densities of the second electrode units change according to a second predetermined ratio.

3. The touch module of claim 2, wherein the first electrode units of the first electrode row and the second electrode units of the second electrode row are arranged interlacedly along the second direction, so as to form a main electrode row.

4. The touch module of claim 3, wherein a side of the main electrode row has a protruding portion and another side of the main electrode row has a recess portion.

5. The touch module of claim 3, wherein the electrode layer further comprises two third electrode rows located at opposite sides of all of the main electrode rows.

6. The touch module of claim 2, wherein the first electrode row and the second electrode row are arranged interlacedly along the first direction.

7. The touch module of claim 2, wherein at least two first electrode rows are connected to a first connecting portion, the first connecting portion is connected to a first conducting wire, at least two second electrode rows are connected to a second connecting portion, and the second connecting portion is connected to a second conducting wire.

8. The touch module of claim 2, wherein each of the first electrode units and each of the second electrode units are formed as a non-triangular polygon.

9. The touch module of claim 2, wherein the densities of the first electrode units decrease gradually according to the first predetermined ratio and the densities of the second electrode units increase gradually according to the second predetermined ratio.

10. The touch module of claim 1, wherein the densities of the first electrode units increase gradually in upward and downward directions according to the first predetermined ratio.

11. The touch module of claim 1, wherein the densities of the first electrode units decrease gradually in upward and downward directions according to the first predetermined ratio.

12. The touch module of claim 2, wherein the first electrode row and the second electrode row are formed on an identical surface of the substrate.
